(19) United States
(12) Patent Application Publication
(10) Pub. No.: US 2010/0332687 A1
(43) Pub. Date: Dec. 30, 2010

(54) METHOD AND APPARATUS FOR RESTRICTING THE EXECUTION OF OPEN SERVICES GATEWAY INITIATIVE (OSGi) LIFE CYCLE COMMANDS

(75) Inventors: DongShin JUNG, Suwon-si (KR); Jooyeol Lee, Seongnam-si (KR); Siddapur Channakeshava Sreekanth, Bangalore (IN); Subramanian Krishnamurthy, Bangalore (IN); Kiran Bharadwaj Vedula, Bangalore (IN)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/826,490

(22) Filed: Jun. 29, 2010

Related U.S. Application Data
(63) Continuation of application No. PCT/KR2008/007852, filed on Dec. 31, 2008.

(30) Foreign Application Priority Data
Dec. 31, 2007 (IN) 3166/CHE/2007

(51) Int. Cl. G06F 3/00; G06F 15/16

(52) U.S. Cl. 710/5; 709/206

(57) ABSTRACT

Method and Open Services Gateway initiative (OSGi) device for selective execution of commands from a controller device in Open Services Gateway initiative (OSGi) framework are provided. The method includes receiving a request for execution of a command from a controller device. The method also includes determining if the command is associated with a unique identifier of the controller device based on a reference database. The reference database stores the unique identifier of the controller device and a set of commands associated with the unique identifier. The method further includes executing the command when the command is associated with the unique identifier.

### CROSS-REFERENCE TO RELATED APPLICATIONS

This application is a continuation of International Application PCT/KR2008/007852, filed on Dec. 31, 2008, which claims the benefit of Indian Patent Application No. 3166/CHE/2007, filed on Dec. 31, 2007, in the Indian Patent Office, the entire disclosure of each of which is incorporated herein by reference for all purposes.

### BACKGROUND

1. Field

The following description relates generally to managing execution of Open Services Gateway initiative (OSGi) life cycle commands. The following description also relates to a method and system for allowing controller devices to execute certain life cycle commands in the OSGi framework.

2. Description of Related Art

In an execution environment, such as Open Services Gateway initiative (OSGi) framework, there are many life cycle commands that the OSGi framework exposes to other devices in a network. For example, a controller device present in the network can execute OSGi lifecycle commands that are provided by the OSGi framework. The controller devices present in the network executes the OSGi life cycle commands to perform operations required by the controller devices. Typically, there can be “N” number of controller devices in the network and all the controller devices can execute the life cycle commands provided by the OSGi framework. “N” can be a positive integer greater than or equal to “1”. As the OSGi lifecycle commands are exposed over the network, there is no barrier or a firewall restricting controller devices from executing some critical OSGi life cycle operations to be performed on the framework. As a result, a malicious controller device in the network can execute some critical OSGi life cycle commands of a framework. This can lead to degradation in the performance of a framework.

### SUMMARY

In one general aspect, there is provided a method of selective execution of commands to from a controller device in an Open Services Gateway initiative (OSGi) framework, the method including: receiving a request for execution of a command from a controller device, determining if the command is associated with a unique identifier of the controller device based on a reference database, the reference database storing the unique identifier of the controller device and a set of commands associated with the unique identifier, and executing the command in response to the commands being associated with the unique identifier.

The method may further include restricting execution of the command in response to the command not being associated with the unique identifier.

The method may further include transmitting an error message to the controller device in response to the command not being associated with the unique identifier.

The method may further include that the error message indicates that the command cannot be executed.

The method may further include that the request for execution of the command includes the unique identifier of the controller device.

The method may further include that the executing is performed by an Open Service Gateway initiative (OSGi) device.

In another general aspect, there is provided an Open Service Gateway initiative (OSGi) device, including: a receiver configured to receive a request for execution of a command from a controller device, a memory module configured to store a reference database, the reference database configured to store a unique identifier of the controller device and a set of commands associated with the unique identifier, and a processor configured to execute the command in response to the set of commands including the command.

The OSGi device may further include that the processor is further configured to restrict execution of the command in response to the set of commands excluding the command.

The OSGi device may further include a transmitter configured to transmit an error message to the controller device in response to the set of commands excluding the command.

The OSGi device may further include that the error message is configured to indicate that the command cannot be executed.

In another general aspect, there is provided a network, including: a controller device, and an Open Service Gateway initiative (OSGi) device, including: a receiver configured to receive a request for execution of a command from the controller device, a memory module configured to store a reference database, the reference database configured to store a unique identifier of the controller device and a set of commands associated with the unique identifier, and a processor configured to execute the command in response to the set of commands including the command.

The network may further include that the processor is further configured to restrict execution of the command in response to the set of commands excluding the command.

The network may further include a transmitter configured to transmit an error message to the controller device in response to the set of commands excluding the command.

The network may further include the error message is configured to indicate that the command cannot be executed.

In another general aspect, there is provided a computer-readable medium storing a method of selective execution of commands from a controller device in an Open Services Gateway initiative (OSGi) framework, including: receiving a request for execution of a command from a controller device, determining if the command is associated with a unique identifier of the controller device based on a reference database, the reference database storing the unique identifier of the controller device and a set of commands associated with the unique identifier, and executing the command in response to the commands being associated with the unique identifier.

The computer-readable medium may further include restricting execution of the command in response to the command not being associated with the unique identifier.

The computer-readable medium may further include transmitting an error message to the controller device in response to the command not being associated with the unique identifier.

The computer-readable medium may further include that the error message indicates that the command cannot be executed.

The computer-readable medium may further include that the request for execution of the command includes the unique identifier of the controller device.

The computer-readable medium may further include that the executing is performed by an Open Service Gateway initiative (OSGi) device.

Other features and aspects may be apparent from the following detailed description, the drawings, and the claims.

### BRIEF DESCRIPTION OF THE DRAWINGS

FIG. 1 is a network in which various embodiments may be practiced.

FIG. 2 is an Open Services Gateway initiative (OSGi) device in accordance with an embodiment.

FIG. 3 is a flow chart depicting a method for selective execution of commands in accordance with an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing operations and/or operations described is an example; however, the sequence of operations and/or operations is not limited to that set forth herein and may be changed as is known in the art, with the exception of operations and/or operations necessarily occurring in a certain order. Also, descriptions of well-known functions and constructions may be omitted for increased clarity and conciseness.

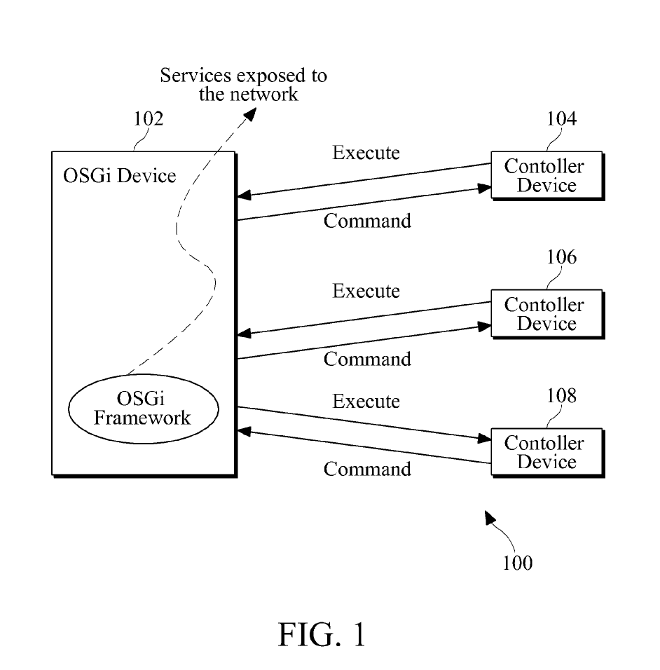

FIG. 1 is a network in which various embodiments can be practiced. An example of the network 100 may include, but is not limited to, a Universal Plug and Play (UPnP) network. The network may include a plurality of Open Services Gateway initiative (OSGi) devices and a plurality of controller devices. For the purpose of example, the network 100 is shown to include an OSGi device 102, a controller device 104, a controller device 106, and a controller device 108. The OSGi device 102 may expose services available at the OSGi device to other devices in the network 100. For example, the OSGi device 102 may expose its service to the controllers 104, 106, and 108. An OSGi framework 110 available at the OSGi device 102 may enable the OSGi device 102 to expose the services to other device in the network 100. The controller devices 104, 106, and/or 108 may execute commands in an OSGi framework 110 to perform operations required by these controller devices. The terms “invoke” and “execute” may be used herein interchangeably.

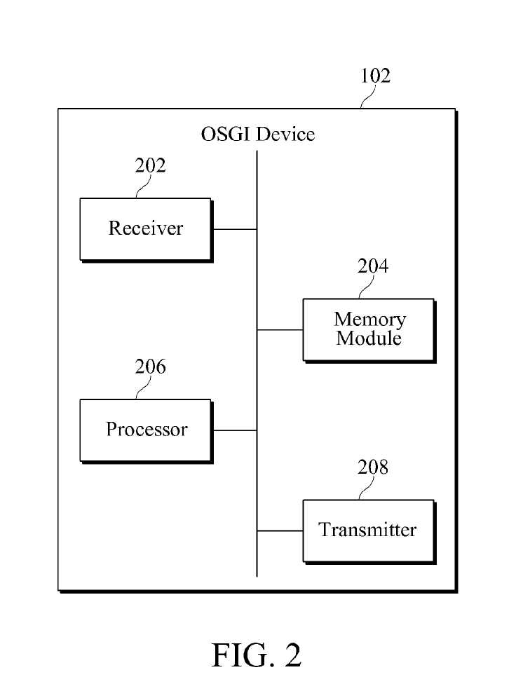

The controller devices 104, 106, and 108 may also execute, for example, some critical life cycle commands in the OSGi framework 110. This may degrade the performance of the OSGi device 102. To prevent such a situation, in which the controller devices 104, 106, and/or 108 may execute some critical lifecycle commands, the OSGi device 108 may be configured to restrict the controller devices 104, 106, and 108 from executing all the commands or some critical lifecycle commands in the OSGi framework 110. For example, the OSGi device 102 may be configured to allow controller devices 104, 106, and 108 to execute certain commands in the OSGi framework 110. Functionalities of OSGi device 102 will be explained with help of FIG. 2.

FIG. 2 is the OSGi device 102, in accordance with an embodiment. In one embodiment, functionalities of the OSGi device 102 may be explained with help of network 100. However, it will be apparent to a person ordinarily skilled in the art that the functionalities of the OSGi device 102 may be explained using any other suitable embodiment. The OSGi device 102 can include a receiver 202, a memory module 204 and a processor 206. The receiver 202 may receive a request for execution of a command from the controller device 104. The controller device 104 may execute the command to perform a particular operation required by the controller device 104. The memory module 204 may store a reference database. The reference database may store a unique identifier of the controller device 104 and a set of commands associated with the unique identifier. Similarly, the reference database may also store unique identifiers of the other controller device and sets of commands corresponding to each of the unique identifier. The reference database may store unique identifiers and sets of commands in form of a hash table, in which each unique identifier may map to a set of commands. An example of the unique identifier includes, but is not limited to, an Internet Protocol (IP) address of the controller device 104.

The processor 206 may execute the command when the command is included in the set of commands associated with the unique identifier of the controller device 104. For example, the processor 206 may execute the command when the controller device 104 is allowed to execute this command. In an embodiment, the processor 206 may also restrict execution of the command when the set of commands excludes the command. For example, the processor 206 may restrict execution of the command in response to a configuration of the OSGi device 102 not allowing the execution of this command. In one embodiment, the OSGi device 102 may also include a transmitter 208 to transmit an error message to the controller device 104 in response to the set of commands excluding the command. For example, the transmitter 208 may transmit the error message in response to the controller device 104 not being allowed to execute this command.

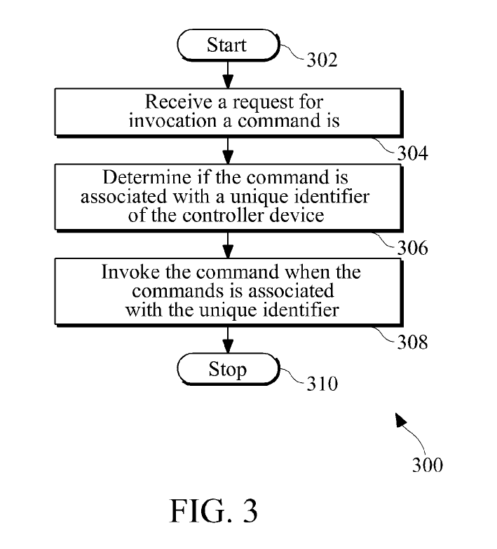

The above example embodiment is explained with help of the OSGi device 102 and the controller device 104. It will be apparent to a person ordinarily skilled in the art, however, that embodiments may be explained/practiced with help of any other suitable OSGi device and controller devices in the network 100. The functionalities of the OSGi device 102 may be used to restrict execution of commands from controller devices in the OSGi framework 110. The method to restrict commands/selective execution of commands from controller devices in the OSGi framework 110 will be explained with the help of FIG. 3.

FIG. 3 illustrates a flowchart depicting a method 300 for selective execution of commands from a controller device in an OSGi framework, in accordance with an embodiment. To explain the method 300, reference will be made to FIGS. 1 and 2. Further, the method 300 can also include more number of operations as depicted in FIG. 3. In operation 302, the method 300 at the OSGi device 102 may be initiated. In operation 304, a request for execution of a command may be received from the controller device 104. In operation 306, it may be determined if the command is associated with a unique identifier of the controller device 104. The processor 206 may determine that the command is associated with the unique identifier based on a reference database. The reference database may store the unique identifier of the controller device and a set of commands associated with the unique identifier. The request for execution of the command may include the unique identifier of the controller device 104. In operation 308, the command may be executed, in response to the command being associated with the unique identifier. In operation 310, the method 300 may end.

In an embodiment, the command may be restricted from being executed when the command is not associated with the unique identifier. For example, configuration of the OSGi device 102 may not allow the execution of this command. In this embodiment, error message may be transmitted to the controller device 104 in response to the command not being associated with the unique identifier. The error message may indicate that the command cannot be invoked or executed.

Embodiments may provide a method and system for restricting the Controller Devices from executing all the Open Services Gateway initiative (OSGi) life cycle commands provided. Further, the system and method may also restrict malicious controller devices from executing some critical operations on a device with OSGi as an execution environment. Embodiments may also provide a more efficient mechanism for mapping a controller device to the commands that the controller device is permitted to execute.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, and devices such as a desktop PC, a high definition television (HDTV), an optical disc player, a setup box, and the like capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of selective execution of commands from a controller device in an Open Services Gateway initiative (OSGi) framework, the method comprising:
receiving a request for execution of a command from a controller device;
determining if the command is associated with a unique identifier of the controller device based on a reference database, the reference database storing the unique identifier of the controller device and a set of commands associated with the unique identifier; and
executing the command in response to the commands being associated with the unique identifier.

2. The method of claim 1, further comprising restricting execution of the command in response to the command not being associated with the unique identifier.

3. The method of claim 1, further comprising transmitting an error message to the controller device in response to the command not being associated with the unique identifier.

4. The method of claim 3, wherein the error message indicates that the command cannot be executed.

5. The method of claim 1, wherein the request for execution of the command comprises the unique identifier of the controller device.

6. The method of claim 1, wherein the executing is performed by an Open Service Gateway initiative (OSGi) device.

7. An Open Service Gateway initiative (OSGi) device, comprising:
a receiver configured to receive a request for execution of a command from a controller device;
a memory module configured to store a reference database, the reference database configured to store a unique identifier of the controller device and a set of commands associated with the unique identifier; and
a processor configured to execute the command in response to the set of commands comprising the command.

8. The OSGi device of claim 5, wherein the processor is further configured to restrict execution of the command in response to the set of commands excluding the command.

9. The OSGi device of claim 5, further comprising a transmitter configured to transmit an error message to the controller device in response to the set of commands excluding the command.

10. The OSGi device of claim 9, wherein the error message is configured to indicate that the command cannot be executed.

11. A network, comprising:
a controller device; and
an Open Service Gateway initiative (OSGi) device, comprising:
a receiver configured to receive a request for execution of a command from the controller device;
a memory module configured to store a reference database, the reference database configured to store a unique identifier of the controller device and a set of commands associated with the unique identifier; and
a processor configured to execute the command in response to the set of commands comprising the command.

12. The network of claim 11, wherein the processor is further configured to restrict execution of the command in response to the set of commands excluding the command.

13. The network of claim 11, further comprising a transmitter configured to transmit an error message to the controller device in response to the set of commands excluding the command.

14. The network of claim 13, wherein the error message is configured to indicate that the command cannot be executed.

15. A computer-readable medium storing a method of selective execution of commands from a controller device in an Open Services Gateway initiative (OSGi) framework, comprising:
receiving a request for execution of a command from a controller device;
determining if the command is associated with a unique identifier of the controller device based on a reference database, the reference database storing the unique identifier of the controller device and a set of commands associated with the unique identifier; and
executing the command in response to the commands being associated with the unique identifier.

16. The computer-readable medium of claim 15, further comprising restricting execution of the command in response to the command not being associated with the unique identifier.

17. The computer-readable medium of claim 15, further comprising transmitting an error message to the controller device in response to the command not being associated with the unique identifier.

18. The computer-readable medium of claim 17, wherein the error message indicates that the command cannot be executed.

19. The computer-readable medium of claim 15, wherein the request for execution of the command comprises the unique identifier of the controller device.

20. The computer-readable medium of claim 15, wherein the executing is performed by an Open Service Gateway initiative (OSGi) device.
